(19) United States
(12) Patent Application Publication
(10) Pub. No.: US 2014/0123502 A1
(43) Pub. Date: May 8, 2014

(54) HAND-HELD UTENSIL, IN PARTICULAR AN ITEM OF TABLEWARE

(71) Applicant: Anne-Laure Benardeau, Lausanne (CH)

(72) Inventor: Anne-Laure Benardeau, Lausanne (CH)

(21) Appl. No.: 14/128,267

(22) PCT Filed: Jun. 14, 2012
(86) PCT No.: PCT/CH2012/000131

§ 371 Date: Jan. 21, 2014

(30) Foreign Application Priority Data
Jun. 21, 2011 (CH) 1055/11

(51) Int. Cl. A47G 21/00; B25G 3/12

(52) U.S. Cl. CPC A47G 21/00; B25G 3/12
USPC 30/342

(57) ABSTRACT

The handheld utensil (10) is in the form of cutlery, and more specifically, in the form of a spoon. This spoon consists of a functional end part (11) and a removable handle (12). These parts are fitted together via complementary interlocking devices which allow the parts to be joined with a releasable action. For this purpose, the end part (11) is fitted with a protruding extension (13), while the handle (12) is fitted with a socket (14) for receiving the extension (13). A shaft (15), on the extension (13), connects with the axial groove (22) in the socket (14) to receive and lock the shaft in place, forming an interlocking device. To complete and reinforce the assembly of the functional end piece (11) and the handle (12), the socket (14) is fitted with a magnet (34). The extension (13) is also fitted with a cooperating mating magnet (33).

This application is a National Stage completion of PCT//CH2012/000131 filed Jun. 14, 2012, which claims priority from Swiss patent application serial no. 1055/11 filed Jun. 21, 2011.

FIELD OF THE INVENTION

This invention relates to a handheld utensil, and in specifically, an item of tableware such as table cutlery, the aforementioned utensil comprising two component parts, one being a functional end part and the other being a removable handle, the aforementioned component parts being fitted with complementary fitment bodies arranged to couple them in a removable way, in which one of the aforesaid component parts being fitted with a protruding extension, the other being fitted with a socket arranged to receive the aforementioned protruding extension, in which the aforementioned functional end part, comprising a first transverse ramp and the aforementioned handle comprising a second transverse ramp of complementary form to that of the first transverse ramp to allow of the aforesaid juxtaposition of the two transverse ramps being defined to cause a relative axial displacement of the two components when one is turned around its axis compared to the other one.

### BACKGROUND OF THE INVENTION

A utensil of this type has already been introduced and described in the

European Patent Publication under EP 1 358 970 by the applicant, in which the specifically important application relates to cutlery in the field called ‘tableware’. One of the original features of this product lies in the fact that the handle is interchangeable, allowing cutlery to be adapted, allowing the table decor as befitting to the specific circumstances or events.

In the tool or utensil described in the aforementioned patent, the bonding strength between the two parts that make up the utensil is basically obtained through the magnetic attraction of the two magnets embedded in each of the two parts. The resulting coupling ensure a gripping force that keeps the two parts, the functional end and the handle, locked into place, which is, in essence, sufficient for everyday use. However, under certain conditions, the pressure applied to the utensil may exceed the mechanical hold obtained by the magnetic bond, and the two components may come apart or be partially separated from each other.

This is an unacceptable inconvenience for products such as table cutlery, which are luxury products, for which even any slight handle disconnection from the functional part—spoon, fork, or knife—and would be an unacceptable defect.

### SUMMARY OF THE INVENTION

This invention is aimed at reducing the inherent disadvantage of the earlier model, mentioned above, by replacing or complementing the magnetic bond with a mechanical coupling device.

To this end, the handheld utensil invention as described in the preamble, is characterized by the aforementioned complementary bodies of fitment comprising moreover a locking mechanism arranged to bind one of the components to the other element, when the two main components are joined by means of the aforementioned complementary fitment bodies.

According to a preferred embodiment, the aforementioned locking mechanism comprises at least an appreciably radial peripheral protuberance spared on one of the aforesaid bodies of complementary fitment and at least an axial groove spared on the other of the aforesaid complementary bodies of fitment, the aforementioned groove being arranged to receive and block in position the aforementioned appreciably radial peripheral protuberance when the two components are coupled with the means of the aforesaid complementary bodies of fitment.

According to an alternative of realization, the aforementioned locking mechanism can comprise two appreciably radial peripheral protuberances spared on one of the aforesaid complementary bodies of fitment and two axial grooves spared on the other of the aforesaid complementary bodies of fitment, the aforementioned grooves being arranged to receive and block in position the aforementioned appreciably radial peripheral protuberances when the two components are coupled with the means of the aforesaid complementary bodies of fitment.

The aforementioned appreciably peripheral protuberances comprise each one preferentially a roughly cylindrical shaft.

To allow the two component parts of the utensil to be well positioned, the aforementioned cylindrical shafts should preferentially have different diameters.

The aforementioned grooves are advantageously spared into a socket laid out longitudinally, parallel to the axis with the aforesaid body of corresponding fitment, and measured to receive the aforementioned shafts.

In keeping with its specific mode of construction, the longitudinal socket is made up of a first section, which is the guiding section and a second section, which is the locking section. The guiding section is made up of grooves with a profile which corresponds with the guiding section of the shafts; the locking section has supple, elastic lateral inner walls on the first section, defining the throttle section which is slightly smaller than that of the shafts, and on the second section, lateral walls define a substantially circular receptacle in which the diameter is the same as the shaft section of the protruding extension.

The protruding extension of one of the parts that make up the utensil has at least one cylindrical section on the circular section that is inserted fully into the center line of the corresponding part. The socket of the other part of the utensil has at least one circular hollow section with a slightly larger diameter than the external diameter of the circular section of the protruding extension of the first part of the utensil.

To allow the interlocking of the two elements, the axial grooves are arranged in the wall of the hollow section of the socket, and the cylindrical shafts are placed on the circular section of the extension.

According to an advantageous embodiment, the aforementioned components equipped with complementary bodies of fitment arranged to couple them in a removable way, respectively comprise moreover a first magnet and a second magnet, the aforementioned second magnet being arranged to enter a zone of magnetic pull of the aforesaid first magnet when the aforementioned end of the aforesaid components is engaged in the aforementioned casing of the other of the aforesaid components.

Preferably, the first and second magnets, on the one hand, and the locking mechanism of one of the components of the utensil on the other are arranged in such a way that the two main components of the utensil are joined simultaneously by both magnetic attraction and mechanical means through the interlocking mechanism.

In keeping with the specific method of construction, the transverse ramp of the functional end of the utensil and the transverse ramp of the handle are curved, where the radius of curvature is between 5 mm and infinity.

This radius of curvature of the curved section of the transverse ramps can be defined in such a way that a relative rotation of the one of the two components around its axis causes a relative axial displacement of these elements.

### BRIEF DESCRIPTION OF THE DRAWINGS

This invention and its advantages will be more apparent in the following description of the assembly, given as a non-limiting example, with reference to the attached drawings in which:

FIG. 1A shows the assembled handheld tool corresponding to the invention in the form of a spoon.

FIG. 1B shows an axial view of the spoon, presented in FIG. 1A.

FIG. 10 shows the spoon, presented in FIG. 1A, when it is disassembled.

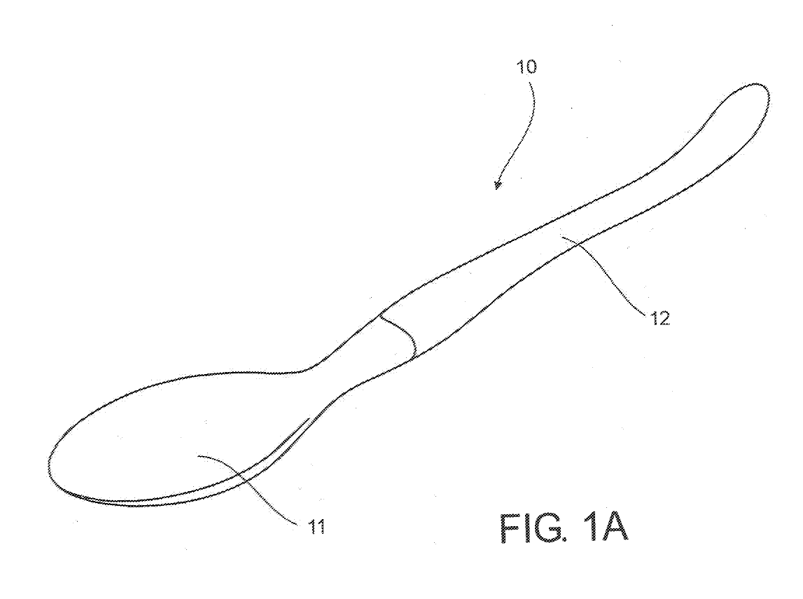

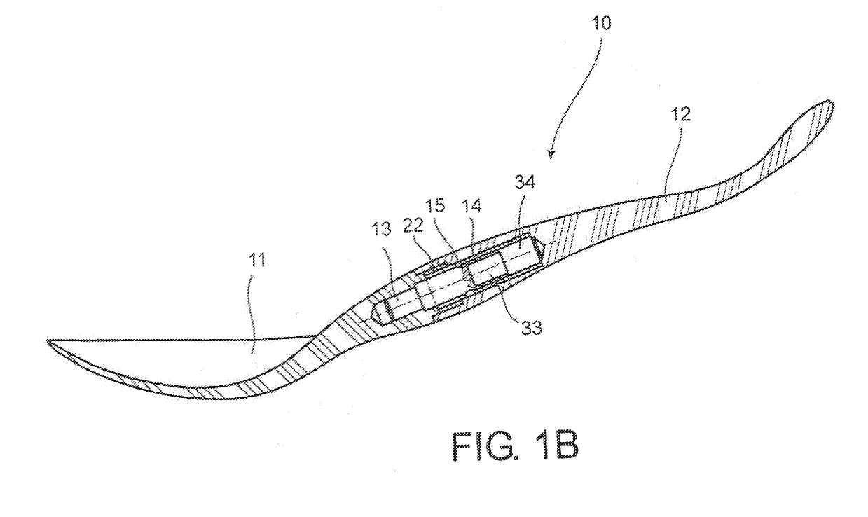

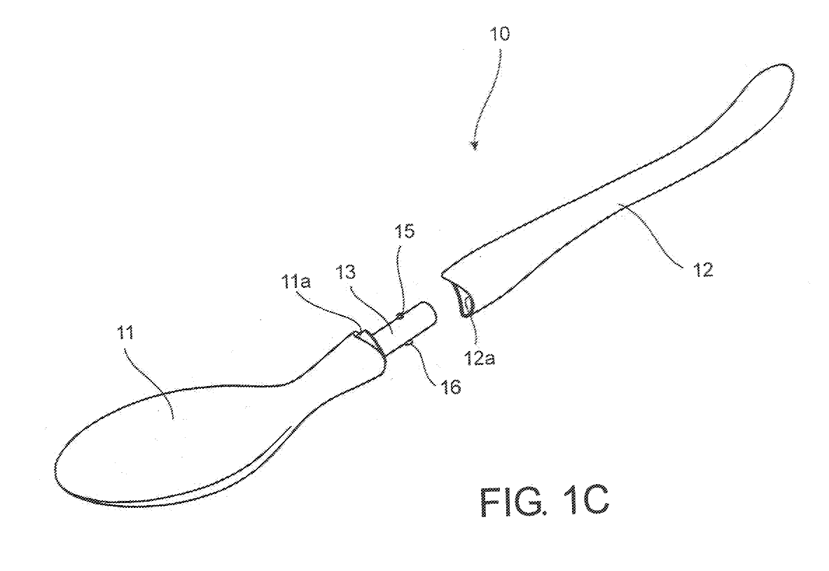

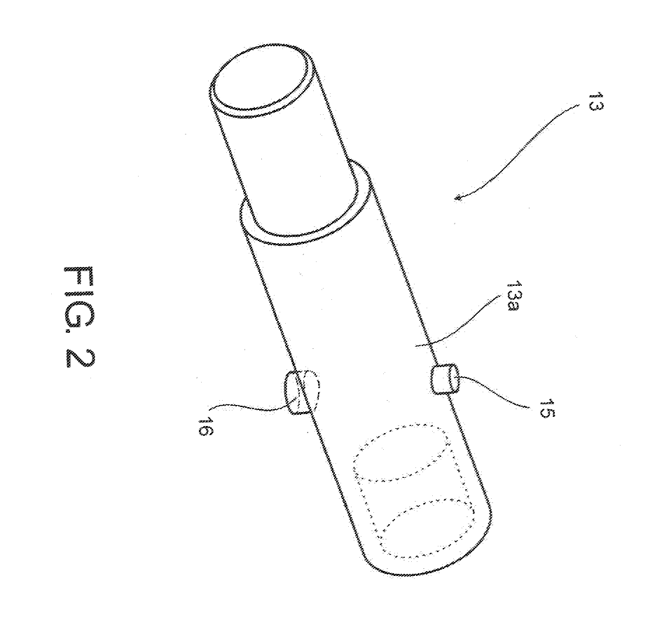

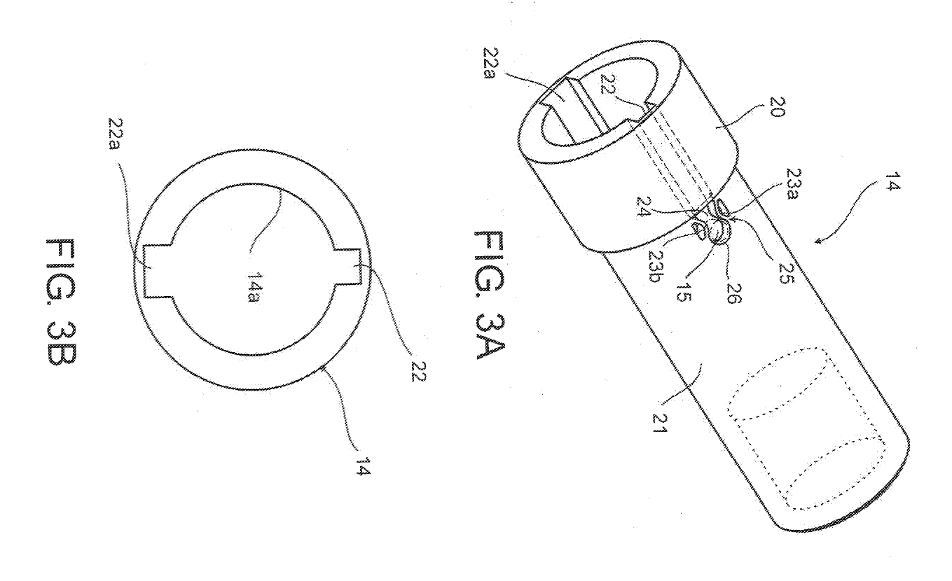

FIG. 2 is a view in perspective of one of the interlocking devices of the two key components of the spoon in FIG. 1 as well as a part of the locking mechanism of the two components.

FIG. 3A is a view in perspective of the other interlocking device of the two key components of the spoon in FIG. 1 as well as a part of the locking mechanism of the two components.

FIG. 3B is a frontal view of the device shown in FIG. 3A.

### DETAILED DESCRIPTION OF THE PREFERRED EMBODIMENTS

With reference to FIG. 1A, the utensil according to the invention is presented as a table cutlery, and in particular, in the form of a spoon 10 which has a functional end piece (11) and a removal handle (12), together making up the two main components of the spoon 10. These component parts are fitted with complementary interlocking devices arranged to enable the utensil components to be connected and to be disassembled. The purpose of inventing cutlery with two detachable components is to enable the aspect, style and decor of the cutlery to be changed to match the desired table decor, in keeping with the occasion of the meal. To this end, it is important to develop methods to join the two components, which should be both discreet and effective: that is, it must be almost invisible to the user and be unfailingly solid to prevent any accidental separation of the two components.

FIG. 1B shows the assembled spoon 10 and illustrates how the two components of this spoon are connected, These means are described in greater detail in FIGS. 2 and 3. The functional end piece (11) is fitted with a protruding extension (13) that is manufactured with this piece, either machined or cast separately and joined to this piece through techniques known per se. The handle (12) is fitted with a socket (14) to receive and lock the aforementioned protruding extension (13). For this purpose, the aforementioned socket (14) has at least one circular hollow section (14a) with a slightly larger diameter than the exterior diameter of the circular section (13a) corresponding to the protruding extension (13). The socket (14) can be machined or cast separately and inserted within the bore appropriately cut into the handle (12) or replaced by a bore with a profile substantially corresponding with that of the protruding extension (13).

To complete and reinforce the assembly of the functional end piece (11) and the handle (12), the socket (14) is fitted with a magnet (34), which is a cylindrical piece embedded within the socket. The extension (13) is also fitted with a magnet (33). which is a cylindrical piece attached to the tip of the extension to work with the socket (14). These two magnets are designed to create a magnetic attraction with each other and to complete or reinforce the bond between the two components of the spoon 10 and, if necessary, to provide the means of supplementary fixation, described in greater detail below.

FIG. 1C shows the spoon 10 in its disassembled form and, more specifically, it represents the functional end piece (11) that is fitted with a protruding extension (13) for joining the end piece to the handle (12). It will be noted that the protruding extension (13), which is a part of one of the interlocking devices and illustrated in greater detail in FIG. 2, has a cylindrical form on the circular section and on its section (13a) at least one protrusion or extension, a shaft (15) which is substantially cylindrical and arranged perpendicularly to the axis of the spoon 10. A second shaft (16) may be provided and arranged diametrically opposite to the first shaft (15). The first shaft (15) or the two shafts (15 and 16) are arranged to be able to slide into the corresponding grooves of the socket (14), thus creating another locking device aimed at guiding the protruding extension (13) on the functional end piece (11) into the socket (14) of the handle (12) when joining the two components of the spoon. This method guarantees a relatively correct positioning of the two components. When the protruding extension (13) is fitted with two shafts (15 and 16), these shafts are not identical in order to reinforce correct positioning. One of the shafts (16) has a larger diameter than the other (15).

The functional end piece (11) and the handle (12), respectively, have ramps (11a, 12a) that are complementary forms, which are juxtaposed when the two components are assembled. These ramps preferentially have at least one curved section where the radius of the curvature may vary from several millimetres—for example, five millimetres—to infinity. In this last case, the ramps are flat, and the relative rotation of one of the components on the other does not induce any relative axial displacement. However, if the radius of the curvature is weak, a relative rotation will cause a more significant relative axial displacement of the two components.

FIGS. 3A and 3B give a more detailed presentation of the locking mechanism to link with one from the components, that is, the functional end piece (11) and the handle (12) when these two components are joined using the complementary interlocking devices. In general terms, the locking mechanism consists of a circular protrusion arranged radially on one of the complementary interlocking devices and another on the other complementary interlocking device to receive the protrusion mentioned above. In this invention, the circular protrusion is a segment of a cylindrical rod or shaft (15) placed perpendicularly to the circumference of the protruding extension (13). The second shaft (16), whether diametrically opposite or not, is designed to guide the protruding extension (13) perfectly into the socket (14). To this end, the socket (14) is made up of a first section, which is the guiding section (20) and a second section, which is the locking section (21). The guiding section (20) is made up of at least one axial groove (22) in the socket section (14a) with a similar profile which corresponds with the guiding section of the shaft (15); the locking section (21) has supple, elastic lateral inner walls (23a, 23b) on the first section (23), which defines the throttle section (24) that is slightly smaller than that of the shafts (15), and on the second section (25), lateral walls define a substantially circular receptacle (26) in which the diameter is the same as the shaft section (15). The hollow section (14a) of the guidance section (20) may have a second internal groove (22a), which may be diametrically opposite to the groove (22), with a similar profile as the shaft (16) to provide guidance for the aforementioned shaft (16). Here, the other guidance and locking components corresponding to the shaft (16) must also be present.

Other solutions are envisaged, namely bayonet-fitting locking mechanisms through which the two component parts of the spoon are connected axially and then turned in relation to each other. The mechanical locking mechanism, combined with the magnetic bonding, makes this a very secure and effective solution, even if this combination is not absolutely necessary.

1-13. (canceled)

14. A handheld utensil for use as tableware, the utensil (10) comprising:
first and second component parts, the first component part being a functional end piece (11) and the second component part being a removable handle (12),
the first and the second component parts being fitted together with complementary coupling members arranged to releasably hold the first and the second component parts together,
one (11) of the first and the second component parts being fitted with a protruding extension (13),
the other (12) of the first and the second component parts being fitted with a socket (14) for engaging with the extension (13),
the functional end piece (11) comprising a first transverse ramp (11a) and the handle (12) comprising a second transverse ramp (12a) having a complementary shape to that of first transverse ramp (11a) for allowing a juxtaposition of the first and the second transverse ramps,
a shape of the first and the second transverse ramps being adapted to provide an axial relative displacement of both the first and the second component parts when one component part is rotated on its axis relatively to the other component part,
wherein the complementary coupling members comprise a locking device adapted to fix one of the first and the second component parts to the other of the first and the second component parts when both the first and the second component parts (11, 12) are coupled by the complementary coupling members.

15. The handheld utensil according to claim 14, wherein the locking device comprises at least one peripheral radial protrusion (15) located on one (13) of the complementary coupling members, and at least an axial groove (22) located on the other one (14) of the complementary coupling members, and the groove (22) is adapted for receiving and locking the one peripheral radial protrusion (15) when both the first and the second component parts (11,12) are coupled by the complementary coupling members.

16. The handheld utensil according to claim 14, wherein the locking device comprises two peripheral radial protrusion (15, 16) located on one (13) of the complementary coupling members, and two axial grooves (22, 22a) located on the other one (14) of the complementary coupling members, the two axial grooves (22, 22a) are adapted to receive and lock the two peripheral radial protrusions (15, 16) when both the first and the second component parts (11, 12) are coupled by the complementary coupling members complementary coupling members.

17. The handheld utensil according to claim 15, wherein the peripheral radial protrusions comprise each a pin (15, 16) having a cylindrical shape.

18. The handheld utensil according to claim 17, wherein the pins (15, 16) have different diameters.

19. The handheld utensil according to claim 16, wherein the two axial grooves (22, 22a) are provided in an axial socket (14) located axially, parallel to the axis of the coupling member and are dimensioned to receive the pins (15, 16).

20. The handheld utensil according to claim 19, wherein the axial socket (14) comprise a first section (20), which comprises a guiding section, and a second section (21), which comprises a locking section, the guiding section (20) comprises the axial grooves (22, 22a) which have a profile which is similar to one of the pins (15, 16), and the locking section (21) have supple, elastic lateral inner walls (23a, 23b) on the first part (23) defining a narrowing (24) having a transverse section which is slightly smaller than that of the pins (15, 16), and on a second part (25) lateral walls defining a substantially circular receptacle (26) having a diameter which is equal to the transverse section of sais pins (15, 16) of the extension (13).

21. The handheld utensil of claim 14, wherein the extension (13) of one (11) of the first and the second component parts comprise at least one section (13a) having a cylindrical shape of circular transverse section which is located mainly on the axis of the relating component part (11), and the socket (14) of the other (12) of the first and the second component parts comprise at least a hollow section (14a) having an inner circular transverse section with a diameter slightly grater than the exterior diameter of the one section (13a) of the extension (13) of the first component part.

22. The handheld utensil of claim 14, wherein the axial grooves (22, 22a) are located on the inner wall of the hollow section (14a) of the socket (14) and the cylindrical pins (15, 16) are located on the one section (13a) and has a circular shape of the extension (13).

23. The handheld utensil of claim 14, wherein the first and the second component parts (11, 12) are provided with complementary coupling members arranged to hold the first and the second component parts releasably together respectively comprise a first magnet (33) and a second magnet (34), the second magnet (34) is adapted to penetrate into a magnetic attraction zone of the first magnet when the extension (13) of the one (11) of the first and the second component parts (11, 12) is inserted in the axial socket (14) of the other one (12) of the first and the second component parts (11, 12).

24. The handheld utensil of claim 23, wherein the first and second magnets, on one hand, and the locking device of one of the first and the second component parts, on the other hand, are adapted to couple the first and the second component parts (11, 12) simultaneously by magnetic attraction and by mechanical means.

25. The handheld utensil of claim 14, wherein the first transverse ramp (11a) of the functional end of the utensil and the second transverse ramp (12a) have a complementary shape and the handle (12) has at least one curved section with a radius of curvature which comprises between 5 mm and infinity.

26. The handheld utensil of claim 23, wherein the radius of curvature of the curved section of the transverse ramps (11a, 12a) is defined so that rotation of one of the first and the second component parts (11, 12) on its axis induce a relative axial displacement of the first and the second component parts.
